(19) United States
(12) Patent Application Publication
(10) Pub. No.: US 2013/0076914 A1
(43) Pub. Date: Mar. 28, 2013

(54) METHOD AND SYSTEM FOR ASSESSMENT OF OPERATOR PERFORMANCE ON AN IMAGING SYSTEM

(71) Applicant: GENERAL ELECTRIC COMPANY, Schenectady, NY (US)

(72) Inventors: Naveen Omesh BENAGI, Bangalore (IN); Raja SHEKHARA, Bangalore (IN)

(73) Assignee: GENERAL ELECTRIC COMPANY, Schenectady, NY (US)

(21) Appl. No.: 13/628,644

(22) Filed: Sep. 27, 2012

(30) Foreign Application Priority Data
Sep. 28, 2011 (IN) 3373/CHE/2011

(51) Int. Cl. H04N 17/00

(52) U.S. Cl. 348/187; 348/E17.002

(57) ABSTRACT

A method for assessing performance of an operator of an imaging system is provided. The method comprises acquiring operator identification information, and acquiring time taken by the operator for initializing the imaging system for an image acquisition, wherein initializing the imaging system comprises at least one activity, and wherein initializing the imaging system is accomplished before a subject to be imaged is exposed for imaging.

### BACKGROUND OF THE INVENTION

Embodiments of the present invention relate generally to imaging systems and, more particularly, to a system and method for assessment of the performance of an operator for initializing an imaging system for an image acquisition,

Imaging systems are an essential pail of clinical screening, diagnostic and/or interventional procedures. Therefore, the efficiency of an imaging functionality and its operator has a significant bearing on the overall efficiency of a healthcare provider providing such screening, diagnostic and/or interventional procedures.

Typically, when executing an image acquisition on an imaging system, an operator takes a specific amount of time for initializing the imaging system before executing a certain imaging protocol on a subject undergoing an imaging procedure. Such a process, typically includes positioning the subject on the imaging system, selecting a certain imaging protocol, selecting various image parameters, and the like. Generally, there exists a significant variation in the time taken by different operators for initializing the imaging system. While some operators may take less time for patient positioning, other operators may take less time for selecting image parameters.

Large variations in the efficiency of operators while initializing the imaging system affects the throughput of the imaging system. Since imaging systems are huge investments, optimal efficiency and utilization is necessary for achieving profitability. Further, efficient imaging procedures are important to reduce the time required for a subject to undergo an imaging procedure, and reduce the wail time for other subjects waiting to undergo an imaging procedure.

Therefore, a need exists for a method and system to assess and enhance the efficiency and performance of an operator of an imaging system.

### BRIEF SUMMARY OF THE INVENTION

In accordance with an embodiment of the present invention, a method for assessing performance of an operator is provided. The method comprises acquiring time taken by the operator, and acquiring time taken by the operator for initializing the imaging system for an image acquisition. Initializing the imaging system comprises at least one activity, and initializing the imaging system is accomplished before a subject to be imaged is exposed for imaging.

In accordance with another embodiment of the present invention, a method of assessing performance of an operator of an imaging system is provided. The method comprises acquiring operator identification information, and acquiring operator timing. Acquiring the operator timing comprises initializing an operator timing to zero when a subject to be imaged is detected, updating the operator timing while the operator performs at least one activity for initializing the imaging system for an image acquisition, stopping the operator timing update when the subject is exposed for imaging, and capturing the operator timing.

In accordance with another embodiment of the present invention, a method for assessing performance of an operator of an imaging system is provided. The method comprises acquiring operator identification information, and acquiring, time taken by the operator for initializing the imaging system for an image acquisition before a subject to be imaged is exposed for imaging. Initializing the imaging system comprises at least one of positioning a subject to be imaged with respect to the imaging system, and selecting at least one parameter for the image acquisition.

In accordance with another embodiment of the present invention, an imaging system for assessing performance of an operator is provided. The system comprises an imaging module for exposing a subject for imaging, a control module used by the operator for controlling operation of the imaging system and for selecting at least one parameter for an image acquisition, an operator performance module for acquiring operator identification information, and a timer for measuring time taken by the operator for initializing the imaging system, wherein initializing the imaging system comprises at least one activity accomplished before the subject is exposed for imaging.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein;

FIG. 1 is a block diagram of an imaging system for assessing and enhancing performance of an operator according to an embodiment of the invention.

FIG. 2 is a flow diagram illustrating an operator performance determination method according to an embodiment of the invention.

FIG. 3 is a flow diagram illustrating a pre-scan initializing method according to an embodiment of the invention.

FIG. 4 is a schematic representation of an operator performance report generated by an imaging system according to an embodiment of the invention.

### DETAILED DESCRIPTION OF THE INVENTION

Various embodiments of the invention provide a method and system for assessing and enhancing the performance of an operator of an imaging system. Specifically, techniques discussed herein provide for acquiring time taken by an operator for initializing an imaging system for executing an image acquisition, and allowing for analysis of such information to improve the time taken by the operator for initializing the imaging system.

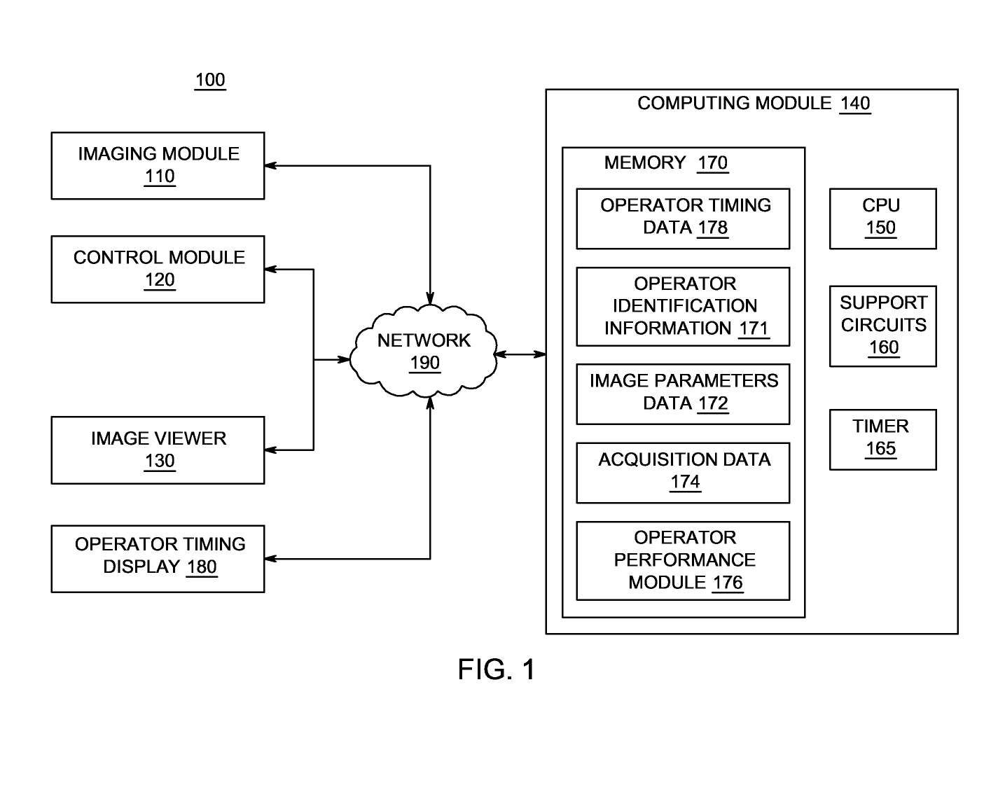

FIG. 1 is a block, diagram of an imaging system 100 for assessing performance of an operator according to an embodiment of the invention. The imaging system 100 includes, for example, an X-ray imaging system, an ultrasound imaging system, a nuclear imaging system, and the like. The imaging system 100 comprises an imaging module 110, a control module 120, an image viewer 130, a computing module 140 and an operator timing display 180, communicably coupled with each other through a communication means, such as, for example, a network 190. The network 190 illustrated in FIG. 1 is one of many possible known modes to communicably couple the various components of the imaging system 100. Direct wired or wireless connections, such as those generally known in the art, may also be used to provide desired communicable coupling between the components of the imaging system 100.

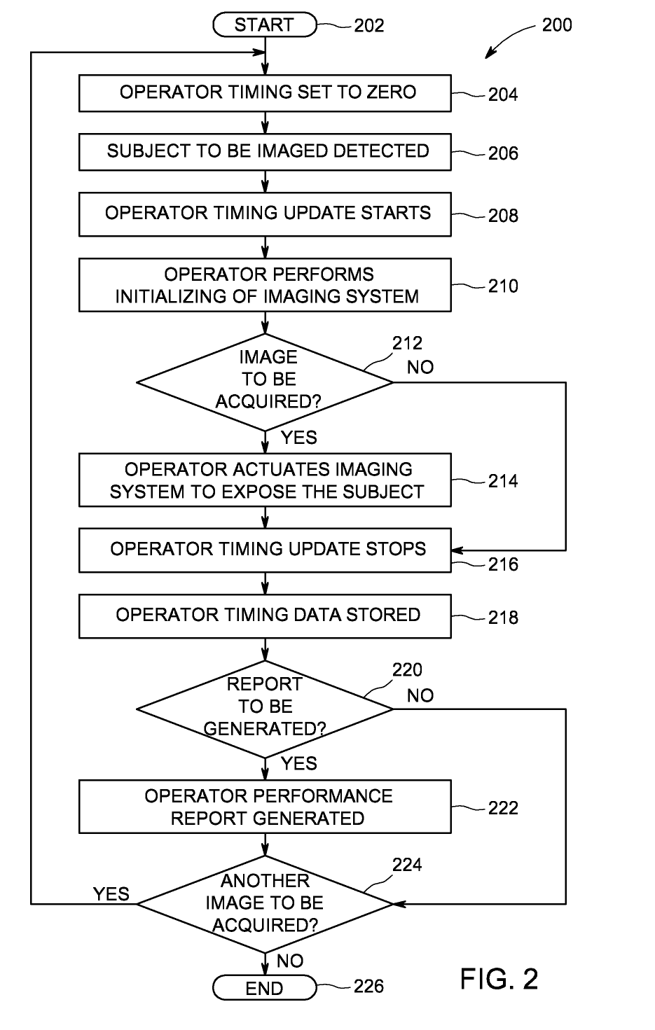

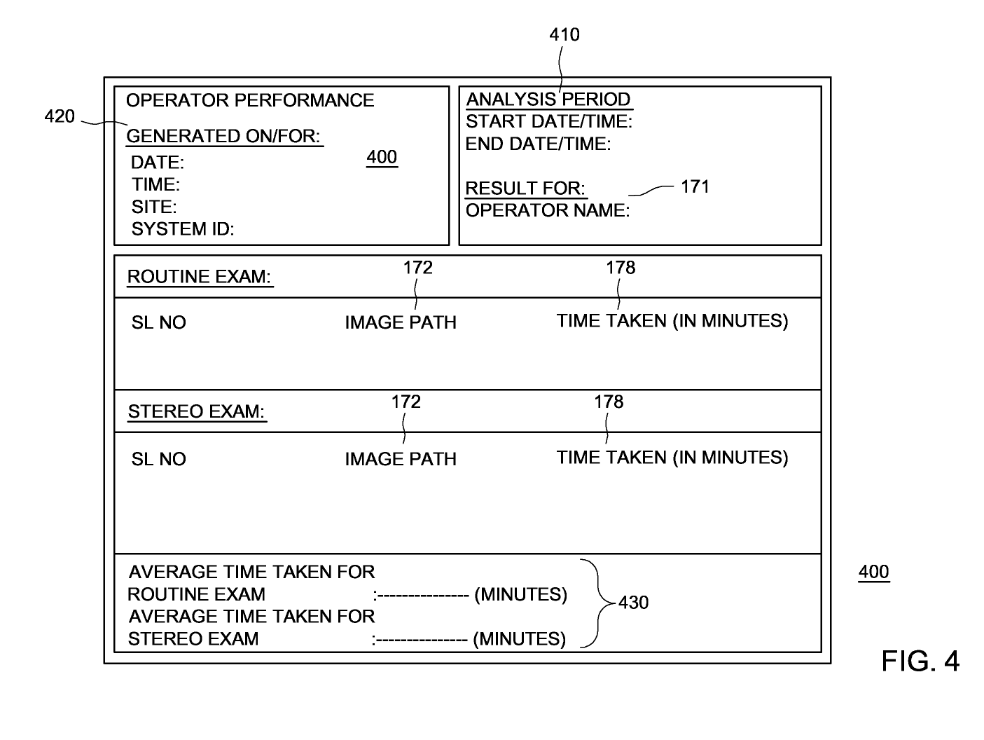

The computing module 140, among other functions, processes the data received from, for example, the imaging module 110 and/or the control module 120, and assists in display of processed and/or unprocessed data on the image viewer 130 and/or the operator timing display 180. The computing module 140 includes, in general, a central processing unit (CPU) 150, support circuits 160, a timer 165 and a memory 170. The CPU 150 may comprise one or more commercially available microprocessors or microcontrollers that facilitate data processing and storage. Various support circuits 160 facilitate operation of the CPU 150 and may include clock circuits, buses, power supplies, input/output circuits and/or the like. The memory 170 includes a Read Only Memory, Random Access Memory, disk drive storage, optical storage, removable storage, and the like. The memory 170 includes data, such as, operator identification information 171, image parameter data 172, acquisition data 174, operator timing data 178, and application software, such as an operator performance module 176, for example. The operator identification information 171, generally a number, a name or a code, uniquely identifies an operator initializing the imaging system 100. The image parameter data 172 includes parameters pertaining, to the image to be acquired, such as, for example, imaging protocol, image path, and the like. The acquisition data 174 captures the instances of an image being acquired, or not acquired, after initializing the imaging system 100 for executing an image acquisition. The operator timing data 178 captures the time taken by the operator for initializing the imaging system 100 for each image acquisition, and may include time taken for one or more activities for initializing the imaging system 100. The timer 165 is a device that measures time taken for an activity, and may include clock circuits as generally known in the art, and in some embodiments, the timer 165 may comprise the clock circuits included in the support circuits 160. The timer 165 may also send time to a display modulo for example, the operator timing display 180. The timer 165 measures time taken by the operator for initializing the imaging system 100 and captures the time measured as, for example, operator timing data 178. The operator performance in 176 implements an operator performance determination method 200, with reference to FIG. 2. The operator performance module 176 acquires and processes the operator identification information 171, the image parameters data 172, the acquisition data 174, and the operator timing data 178, for example, to generate an operator performance report 400, with reference to FIG. 4.

The imaging module 110 is configured to acquire images of a subject. In one embodiment, for example, the imaging system 100 is a mammography system, and the imaging module 110 is configured to acquire a mammographic image by exposing the subject to X rays. The control module 120 is an interface for the operator for controlling the operations of the imaging system 100. For example, the operator may use the control module 120 for selecting parameters for the images to be acquired. The images acquired by the imaging module 110 may be displayed on a display device, for example, the image viewer 130.

As discussed, initializing the imaging system 100 includes one or more activities accomplished by the operator, before the subject to be imaged is exposed for imaging. For example, activities of the operator include, without limitation, positioning a subject (a patient) with respect to the imaging system 100. Another activity, for example, includes selecting at least one parameter for executing each image acquisition. While various embodiments discussed herein refer to activities as discussed above, those skilled in the art will appreciate that the embodiments are not limited to the specific activities discussed above.

FIG. 2 is a flow diagram illustrating the operator performance determination method 200 according to an embodiment of the invention. The operator performance determination method 200 starts at step 202 and proceeds to step 204. At the step 204, operator timing is set to zero by, for example, the timer 165 of FIG. 1. At step 206, subject to be imaged is detected by the imaging system 100. The subject to be imaged may be detected by the imaging system 100 automatically by several techniques generally known in the art. For example the subject to be imaged may be detected by interference caused by the presence of the subject in an energy beam path traversing between the X-ray source and detectors.

Subsequent to detection of the subject to be imaged at step 206, operator timing update starts at step 208. It is noted that while in the illustrated embodiment, the subject to be imaged is automatically detected at step 206, in another embodiment, the step 206 may include a manual input to detect the subject to be imaged.

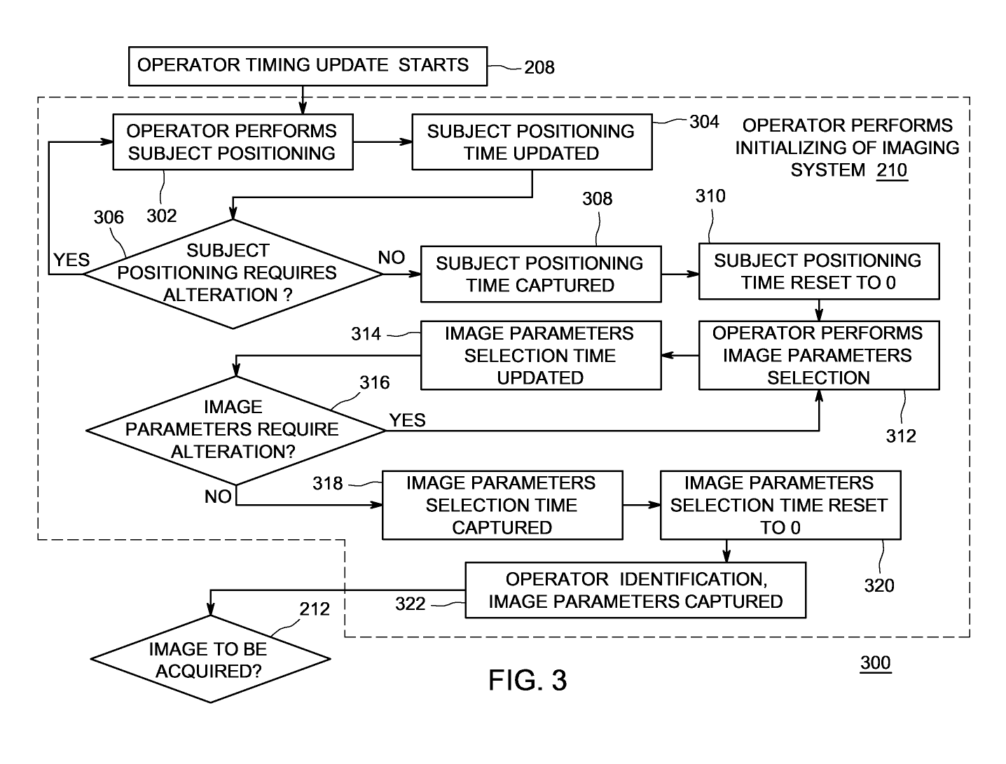

At step 210, the operator performs initializing of the imaging system 100. Initializing the imaging system 100 includes at least one activity be accomplished by the operator before the subject to be imaged is exposed for imaging. The at least one activity accomplished by the operator includes for example, positioning the subject to be imaged with respect to the imaging system 100, selecting parameters for the image to be acquired, and the like. Image parameters, for example, include an image path, and according, to an embodiment, the image path for an X-ray imaging system may be selected by the operator as a routine examination, or a stereoscopic examination. Step 210 is described in detail below with reference to a pre-scan initializing method 300 of FIG. 3.

At step 212 a determination is made whether an image is to be acquired. If the image is to be acquired (option “YES”), the operator performance determination method 200 proceeds to step 214. At step 214, the operator actuates the imaging module 110 to expose the subject to be imaged and the operator timing update stops at step 216. If initializing the imaging system 100 is followed by an image acquisition, as is described here, the acquisition data 174 of FIG, 1 is captured as “YES”.

If at the step 212, a determination is made that an image is not to be acquired (option “NO”), the operator timing update stops at step 216 and the acquisition data 174 of FIG. 1 is captured as “NO”. The acquisition data captured as “NO” indicates that initializing of the imaging system 100 has not been followed by an image acquisition. At step 218, the operator timing data measured by the timer 165, is stored as, for example, the operator timing data 178 of FIG. 1.

The operator performance determination method 200 proceeds to step 220, at which a determination is made whether a report is to be generated. If a report is to he generated (option. “YES”) an operator performance report, for example, an operator performance report 400 of FIG. 4 is generated at step 222 and the operator performance determination method 200 proceeds to step 224. The operator performance report 400 includes at least the operator timing data 178 and the operator identification information 171. The operator performance report 400 is described in detail below with reference to FIG. 4. If at the step 220, a determination is made that a report is not to be generated (option “NO”), the operator performance determination method 200 proceeds to step 224.

At the step 224 a determination is made whether another image acquisition is required. If another image acquisition is required (option “YES”), the operator performance determination method 200 returns to the step 204. If at the step 224 a determination is made that another image acquisition is not required (option “NO”), the operator performance determination method 200 ends at step 226.

According to the embodiment illustrated by FIG. 2 operator timing update starts for example, at step 208 when the operator starts initializing the imaging system 100 and stops for example, when either a determination is made to acquire or not to acquire an image (at step 212). Therefore, the operator timing data captures the time that the operator requires for initializing the imaging system 100 for executing an image acquisition. One skilled in the art will appreciate that such operator timing data may include idle time, for example, time interval for which the operator leaves the imaging system 100 idle, subsequent to start of update of operator timing at step 208 and before stop of update of operator timing at step 216 or step 222.

Further, the steps described for the operator performance determination method 200 of FIG. 2 are described here only as an example, and not as a limitation of a routine imaging process. It is appreciated that the steps of an imaging process may vary in order or number depending on the type of imaging system 100, as is generally known in the art, and all such variations are included within the scope and spirit of the present invention.

FIG. 3 is a flow diagram illustrating a pre-scan initializing method 300 according to an embodiment of the invention. The pre-scan initializing method 300 includes at least one activity accomplished by the operator involving the imaging system 10) before the subject to be imaged is exposed for imaging. According to the embodiment illustrated in FIG. 3, the pre-scan initializing method 300 includes subject positioning, image parameters selection and capturing operator identification. However, those skilled in the art will appreciate that the pre-scan initializing method 300, may vary for example, according to the type of imaging system 100. For example, in alternate embodiments, image parameters selection may be an automated function, instead of requiring operator involvement, and several other such variations known in the art are included within the scope and spirit of the present invention.

According to one embodiment, subsequent to step 208, at which operator timing update starts, the pre-scan initializing method 300 starts with subject positioning at step 302. At step 302, the operator positions the subject to be imaged with respect to the imaging system 100. At step 304, time taken by the operator for subject positioning is updated.

At step 306, a determination is made whether subject positioning requires alteration. If subject positioning requires alteration (option “YES”), the pre-scan initializing method 300 returns to step 302. If subject positioning does not require alteration (option “NO”), the pre-scan initializing method 300 proceeds to step 308. At the step 308, the subject positioning time is captured. At step 310 subject positioning time is reset to zero to facilitate capture of subject positioning time for a subsequent pre-scan initializing.

At step 312, operator performs image parameters selection. At step 314, time taken by the operator for image parameters selection is updated. At step 316, a determination is made whether image parameters require alteration. If image parameters require alteration (option “YES”), the pre-scan initializing method 300 returns to step 312. If image parameters do not require alteration (option “NO”), the pre-scan initializing method 300 proceeds to step 318. At step 318, the image parameters selection time is captured. At step 320 image parameters selection time is reset to zero to facilitate capture of image parameters selection time for a subsequent pre-scan initializing and the pre-scan initializing method 300 proceeds to step 322.

At step 322, operator identification and image parameters are captured. Operator identification and image parameters captured here are stored as, for example the operator identification information 171 and the image parameters data 172 respectively in the memory 170 of FIG. 1

According to one embodiment, the time taken by the operator for initializing the imaging apparatus 100 for executing an image acquisition is computed by adding the time captured for each of the activities performed by the operator. For example, the time taken by the operator for initializing the imaging apparatus 100 for executing an image acquisition may be the sum of the subject positioning time captured at the step 308 and the image parameters selection time captured at the step 318.

As discussed, FIG. 4 illustrates a schematic representation of the operator performance report 400 generated by the imaging system 100 according to an embodiment of the invention. According to one embodiment, the operator performance report 400 includes an analysis period 410, a report identification detail 420, the operator identification information 171, the image parameters data 172, the operator timing data 178, and an operator performance measure 430.

The operator performance module 176 captures the analysis period 410, the report identification detail 420 and computes the operator performance measure 430. Capture of the analysis period 410, the report identification detail 420 and computation of the operator performance measure 430 are not shown in the operator performance determination method 200, for the sake of simplicity of representing the operator performance determination method 200.

The analysis period 410 is the time period for which the operator performance search report 400 is generated. The operator performance search report 400 may for example be generated for each initializing of the imaging system 100, or after performing multiple initializations of the imaging system 100 According to an embodiment, the operator performance search report 400 is generated according to a determination made at step 230 of the operator performance determination method 200. One skilled in the art will appreciate that determination of generating the operator performance report 400 may require a manual input or may be automated and the operator performance report 400 may for example, be generated at predetermined time periods like daily, weekly or monthly.

According to an embodiment, the report identification detail 420 includes date of report generation, time of report generation, identification information for location of the imaging system 100, and identification information for the imaging system 100.

Further, the operator performance measure 430 is for example, computed as average time taken for the operator to perform initializing of the imaging system 100 for executing multiple image acquisitions corresponding to one image path. For example, as illustrated in the operator performance report 400 of FIG. 4, the operator performance measure 430 is computed as average time taken by the operator to perform initializing for a routine exam and average time taken by the operator to perform initializing for a stereo exam.

According to one embodiment, the operator performance report 400 is generated for enhancing the performance of the operator. One skilled in the art will appreciate that the operator performance report 400 may include various other imaging system details, image parameters details or operator performance measures that may facilitate in enhancing the performance of the operator, and the embodiment illustrated by FIG. 4 is not intended to limit the scope and spirit of the present invention.

According to one embodiment, the operator performance measure 430 may for example, be computed as average time taken by the operator to perform subject positioning or selecting image parameters for multiple initializations of the imaging system 100. Further, the operator performance report 400 may include the acquisition data 174 to provide a count of number of times an image is not acquired after performing initializing of the imaging system 100.

Such operator performance measures provide useful information for identifying the particular activity that the operator is efficient or inefficient in. For example, such performance measures may allow insight into data that the operator requires more time for initializing the imaging system because the operator requires more time for positioning the subject with respect to the imaging system. The operator can then be trained for efficient patient positioning to enhance performance.

The various embodiments discussed herein achieve the technical effect of acquiring time taken by an operator for performing pre-scan initializing of an imaging system and such information offers various advantages. Time taken by an operator for performing pre-scan initializing of an imaging system is useful information that reflects on the efficiency of the operator and in turn the efficiency of usage of imaging system being operated by the operator. Concerned entities, for example, healthcare providers, may use such information for educating and training the operator to assess query and enhance the performance of the operator. Enhanced performance of operators improves the revenue generation for healthcare providers.

Further, enhanced performance of operators reduces the patient waiting time for an imaging procedure. Advantageously, various embodiments discussed herein benefit both the healthcare providers and the patients, and are also compatible and implementable with the presently used imaging systems.

While only certain features of the invention have been illustrated and described herein, modifications and changes will occur to those skilled in the art. It is, therefore, to be understood that the appended claims are intended to cover all such modifications and changes as fall within the true spirit of various embodiments of the invention.

What is claimed is:

1. A method for assessing performance of an operator of an imaging system, the method comprising:
acquiring operator identification information:, and
acquiring time taken by the operator for initializing the imaging system for an image acquisition, wherein initializing the imaging system comprises at least one activity, and wherein initializing the imaging system is accomplished before a subject to be imaged is exposed for imaging.

2. The method of claim 1, wherein the at least one activity comprises positioning the subject to be imaged with respect to the imaging system.

3. The method of claim 1, wherein the at least one activity comprises selecting at least one parameter for the image acquisition.

4. The method of claim 3, wherein the at least one parameter comprises one or more of an image path, and an imaging protocol.

5. The method of claim 1, wherein assessing performance of an operator further comprises generating an operator performance report comprising:
the time taken by the operator for initializing the imaging system and
the operator identification information.

6. The method of claim 1, wherein assessing performance of the operator further comprises acquiring time taken for each of the at least one activity.

7. The method of claim 1, wherein assessing performance of the operator further comprises determining and reporting whether the operator exposed the subject to be imaged, after initializing the imaging system.

8. The method of claim 3, wherein assessing performance of the operator further comprises acquiring and reporting the at least one parameter selected for the image acquisition.

9. A method of assessing performance of an operator of an imaging system, the method comprising:
acquiring operator identification information; and
acquiring operator timing, wherein acquiring the operator timing comprises:
initializing an operator timing to zero when a subject to be imaged is detected;
updating the operator timing while the operator performs at least one activity for initializing the imaging system for an image acquisition;
stopping the operator timing update when the subject is exposed for imaging; and
capturing the operator timing.

10. The method of claim 9, wherein the at least one activity comprises positioning the subject to be imaged with respect to the imaging, system.

11. The method of claim 9, wherein the at least one activity comprises selecting at least one parameter for the image acquisition,

12. The method of claim 9, wherein assessing performance of the operator further comprises generating an operator performance report, wherein the operator performance report comprises:
the operator identification information; and
the operator timing.

13. A method for assessing performance of an operator of an imaging system, the method comprising:
acquiring operator identification information; and
acquiring time taken by the operator for initializing the imaging system for an image acquisition before a subject to be imaged is exposed for imaging, wherein initializing the imaging system comprises at least one of:
positioning a subject to be imaged with respect to the imaging system; and
selecting at least one parameter for the image acquisition.

14. An imaging system for assessing performance of an operator, the system comprising:
an imaging module for exposing a subject for imaging;
a control module used by the operator for controlling operation of the imaging system and for selecting at least one parameter for an image acquisition;
an operator performance module for acquiring operator identification information; and
a timer for measuring time taken by the operator for initializing the imaging system, wherein initializing the imaging system comprises at least one activity accomplished before the subject is exposed for imaging.

15. The imaging system of claim 14, wherein the imaging system comprises one of an X-ray imaging system, an ultrasound imaging system, and a nuclear imaging system.

16. The imaging system of claim 14, wherein the operator performance module further acquires the at least one parameter selected for the image acquisition.

17. The imaging system of claim 14, wherein the timer measures time taken by the operator for each of the at least one activity.

18. The imaging system of claim 14, wherein the operator performance module further determines whether the operator exposed the subject to be imaged, after initializing the imaging system.

19. The imaging system of claim 14, wherein the operator performance module generates an operator performance report comprising the time taken by the operator for initializing the imaging system, and the operator identification information.
